(19) United States
(12) Patent Application Publication
(10) Pub. No.: US 2024/0154217 A1
(43) Pub. Date: May 9, 2024

(54) Secondary Battery, Manufacturing Method Thereof, and Device Including the Same

(71) Applicant: LG Energy Solution, Ltd., Seoul (KR)

(72) Inventor: Jinhyeong Choi, Daejeon (KR)

(73) Assignee: LG Energy Solution, Ltd., Seoul (KR)

(21) Appl. No.: 18/284,232

(22) PCT Filed: Oct. 14, 2022
(86) PCT No.: PCT/KR2022/015629

§ 371 Date: Sep. 26, 2023

(30) Foreign Application Priority Data
Oct. 18, 2021 (KR) 10-2021-0138334

(51) Int. Cl. H01M 50/136; H01M 50/116; H01M 50/233

(52) U.S. Cl. CPC H01M 50/136; H01M 50/233; H01M 50/116

(57) ABSTRACT

A secondary battery according to one embodiment of the present disclosure may includes an electrode assembly a first battery case that houses the electrode assembly and a second battery case that houses the first battery. The second battery case may be formed to have a different color from that of the first battery case.

### CROSS-REFERENCE TO RELATED APPLICATIONS

This application is a national phase entry under 35 U.S.C. § 371 of International Application No. PCT/KR2022/015629 filed on Oct. 14, 2022, which claims the benefit of Korean Patent Application No. 10-2021-0138334 filed on Oct. 18, 2021, with the Korean Intellectual Property Office, the entire contents of both of which are incorporated herein by reference.

### TECHNICAL FIELD

The present disclosure relates to a secondary battery and a device including the same, and more particularly to a secondary battery capable of indicating an expansion of the secondary battery, and a device including the same

### BACKGROUND

Recently, the demand for portable electronic products such as notebooks, video cameras, cellular phones or the like has rapidly increased, and electric vehicles, energy storage batteries, robots, satellites or the like have been actively developed. Thereby, many studies have been conducted on the secondary battery used as its driving power source.

Depending on the shape of the battery case, a secondary battery is classified into a cylindrical battery where an electrode assembly is built into a cylindrical metal can, a prismatic battery where an electrode assembly is built into a prismatic metal can, and a pouch-type battery where an electrode assembly is built into a pouch type case formed of an aluminum laminate sheet.

The electrode assembly built into the battery case is an electricity-generating device enabling charge and discharge that has a positive electrode/separator/negative electrode laminate structure, and is classified into a jelly-roll type, a stack type, and a stack/folding type. The jelly-roll type is a shape in which a positive electrode and a negative electrode, each made of an active material-coated long sheet, is rolled with a separator interposed between them, the stack type is a shape in which a plurality of positive electrodes and a plurality of negative electrodes each having a predetermined size are laminated in this order in a state where a separator is interposed therebetween, and a stack/folding type is a combination of a jelly-roll type and a stack type. Of these, the jelly-roll-type electrode assembly has advantages that manufacture is easy and the energy density per weight is high.

Meanwhile, the secondary battery includes, for example, a nickel cadmium battery, a nickel hydrogen battery, a nickel zinc battery, a lithium secondary battery, and the like. Among them, the lithium secondary batteries are widely used in the field of high-tech electronic devices because they have advantages, for example, hardly exhibiting memory effects in comparison with nickel-based secondary batteries and thus being freely charged and discharged, and having very low self-discharge rate, high operating voltage and high energy density per unit weight.

Moreover, as the electrolyte is decomposed or side reactions occur in the secondary battery during the cycle, a swelling phenomenon due to gas generation may occur. As the cycle progresses, the degree of gas generation can be observed, and the degradation of the corresponding secondary battery, and the like can be observed. However, in conventional secondary batteries, there is known no method for clearly observing the swelling phenomenon with the naked eye.

Therefore, because it is necessary to clearly identify the presence or absence of the swelling phenomenon with the naked eye and to assess the degree of expansion, there is a need for a new structure that can solve the above problems.

### DETAILED DESCRIPTION OF THE INVENTION

### Technical Problem

It is an object of the present disclosure to provide a secondary battery capable of indicating an expansion of the secondary battery, and a device including the same.

However, the technical problem to be solved by embodiments of the present disclosure is not limited to the above-described problems, and can be variously expanded within the scope of the technical idea included in the present disclosure.

### Technical Solution

According to one embodiment of the present disclosure, there is provided a secondary battery comprising: an electrode assembly; a first battery case that houses the electrode assembly; and a second battery case that houses the first battery, wherein the second battery case is formed to have a different color from that of the first battery case.

A groove may be formed in the second battery case.

A plurality of grooves may be formed on the second battery case.

The plurality of grooves may be formed to be spaced apart from each other on the second battery case.

The second battery case may be configured such that during expansion of a battery, a portion of the second battery case in which the groove is formed is ruptured.

As the second battery case is ruptured, the groove may be connected to the first battery case.

As the second battery case is ruptured, the first battery case may be exposed to the outside.

The first battery case and the second battery case may be formed to have different materials from each other.

The first battery case may be formed to have greater deformability than the second battery case.

According to another embodiment of the present disclosure, there is provided a method of manufacturing a secondary battery, comprising the steps of: housing an electrode assembly in a first battery case; and covering the first battery case in which the electrode assembly is housed with a second battery case, wherein the second battery case is formed to have a color different from that of the first battery case.

A groove may be formed in the second battery case.

According to yet another embodiment of the present disclosure, there is provided a device comprising the above-mentioned secondary battery.

### Advantageous Effects

According to embodiments of the present disclosure, the first battery case and the second battery case are formed in different colors, and a groove is formed on the second battery case, thereby capable of confirming expansion of the secondary battery with the naked eye.

In addition, the degree of expansion can be confirmed through the change in the size of the groove formed as the second case is torn.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is a perspective view showing a pouch-type secondary battery according to an embodiment of the present disclosure;

FIG. 2 is a perspective view showing a cylindrical secondary battery according to an embodiment of the present disclosure;

FIG. 3 is a perspective view showing a prismatic secondary battery according to an embodiment of the present disclosure;

FIG. 4 is a partially exploded perspective view of a pouch-type battery according to an embodiment of the present disclosure;

FIG. 5 is a perspective view of the secondary battery of FIG. 4 with a second battery case;

FIG. 6 is a diagram showing a cross section cut along the line A-A′ of FIG. 5;

FIG. 7 is an enlarged view of a section C of FIG. 6;

FIG. 8 is a cross-section showing the secondary battery of FIG. 6 in an expanded state;

FIG. 9 is an enlarged view of a section D of FIG. 8; and

FIG. 10 is an enlarged view of a section B of FIG. 5 showing a state in which a first and the second battery cases change due to expansion of the secondary battery.

### DETAILED DESCRIPTION OF THE EMBODIMENTS

Hereinafter, various embodiments of the present disclosure will be described in detail with reference to the accompanying drawings so that those skilled in the art can easily carry out them. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggeratedly illustrated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” toward an opposite direction of gravity.

Further, throughout the description, when a portion is referred to as “including” or “comprising” a certain component, it means that the portion can further include other components, without excluding the other components, unless otherwise stated.

Further, throughout the description, when it is referred to as “planar”, it means when a target portion is viewed from the upper side, and when it is referred to as “cross-sectional”, it means when a target portion is viewed from the side of a cross section cut vertically.

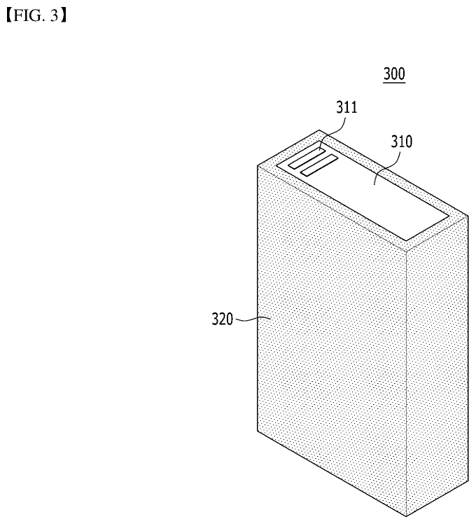

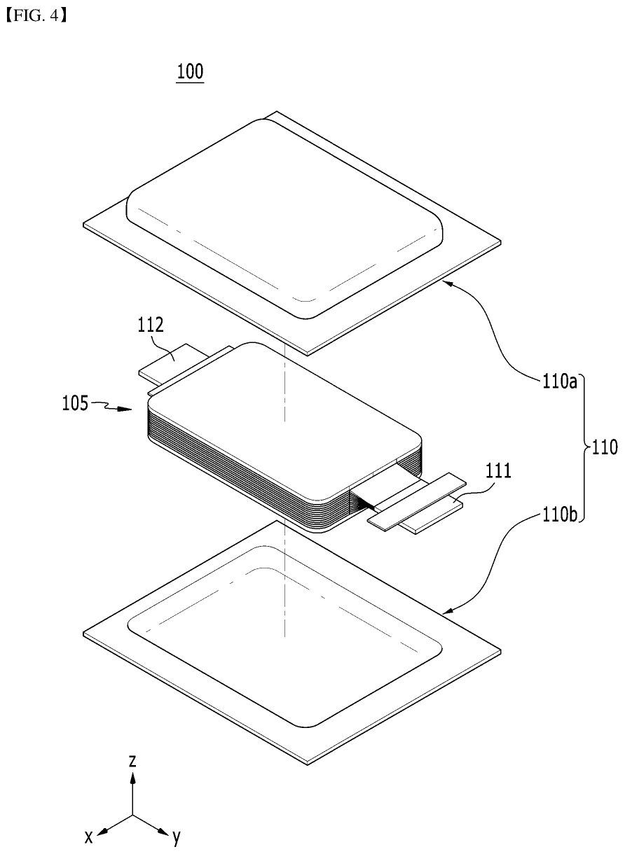

FIG. 3 is a side view showing a side surface of a magnetic filter according to an embodiment of the present disclosure. FIG. 4 is a cross-sectional view taken along the line A-A′ of FIG. 3.

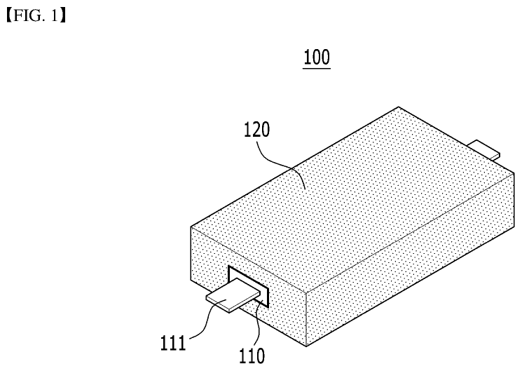

Now, a secondary battery according to an embodiment of the present disclosure will be described with reference to FIGS. 1 to 4.

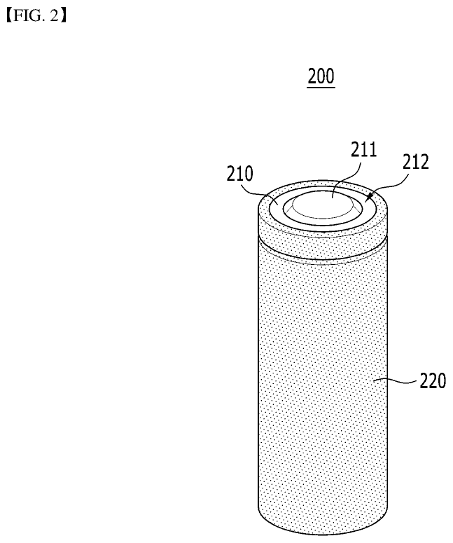

FIG. 1 is a perspective view showing a pouch-type battery among secondary batteries according to an embodiment of the present disclosure. FIG. 2 is a perspective view showing a cylindrical battery among secondary batteries according to an embodiment of the present disclosure. FIG. 3 is a perspective view showing a prismatic battery among secondary batteries according to an embodiment of the present disclosure. FIG. 4 is a partially exploded perspective view of a pouch-type battery according to an embodiment of the present disclosure.

Referring to FIGS. 1 and 4, the secondary battery 100 according to the present embodiment is a pouch-type secondary battery, and can be manufactured by housing the electrode assembly 105 inside the first battery case 110 and then sealing the case.

The electrode assembly 105 may include a positive electrode, a negative electrode, and a separator disposed between the positive electrode and the negative electrode.

Each of the positive electrode and the negative electrode includes a positive electrode tab and a negative electrode tab, and a positive lead 111 connected to the positive tabs and a negative lead 112 connected to the negative tabs may be exposed to the outside of the first battery case 110. At this time, the positive lead 111 and the negative lead 112 may function as electrode terminals. The positive lead 111 and the negative lead 112 may be collectively referred to as electrode leads 111 and 112.

The first battery case 110 is made of a laminate sheet, and may include a resin layer for heat sealing and a metal layer for preventing material penetration.

The first battery case 110 may include an upper case 110a and a lower case 110b. Each of the upper case 110a and the lower case 110b may be formed with separate housing parts in which the electrode assembly 20 can be seated.

Meanwhile, the pouch-type battery 100 shows a bidirectional battery in which the positive electrode lead 111 and the negative electrode lead 112 protrude in mutually opposite directions, but the pouch-type battery 100 of the present disclosure is not limited to such a form, and includes a unidirectional battery in which the positive electrode lead 111 and the negative electrode lead 112 protrude in the same direction, and a step-type battery having a stepped part is formed in an electrode assembly housing part. In particular, referring to FIG. 4, a step-type battery having a step in the electrode assembly housing part can be confirmed.

Referring to FIG. 2, the cylindrical battery 200 includes a first cylindrical battery case 210 made of a metal material, and includes a second cylindrical battery case 220 covering the first cylindrical battery case 210.

In the cylindrical battery 200, a top cap protruding upward may function as a positive electrode terminal 211, and a crimping part 212 may function as a negative electrode terminal. Therefore, the second battery case 220 may cover the entire top cap functioning as an electrode terminal and the remaining portion except a portion of the crimping part 212.

Referring to FIG. 3, the prismatic battery 300 includes a prismatic first battery case 310 made of a metal material, and includes a prismatic second battery case 320 covering the prismatic first battery case 310.

The prismatic battery 300 is arranged so that the electrode terminal 311 is exposed on the upper surface. Thus, the prismatic second battery case 320 may be formed on the remaining upper surface except the portion where the electrode terminals 311 are exposed on the upper surface, the entire side surface of the prismatic first battery case 310, and the entire lower surface of the prismatic first battery case 310. That is, the prismatic second battery case 320 may cover the remaining prismatic first battery case 310 except the electrode terminal 311.

Next, a second battery case formed in a secondary battery according to an embodiment of the present disclosure will be described in detail with reference to FIGS. 5 to 10. The pouch-type battery is mainly described, but a shape in which the pouch-type battery is changed to the cylindrical battery and the prismatic battery shown in FIGS. 2 and 3 is also included in the scope of the present disclosure.

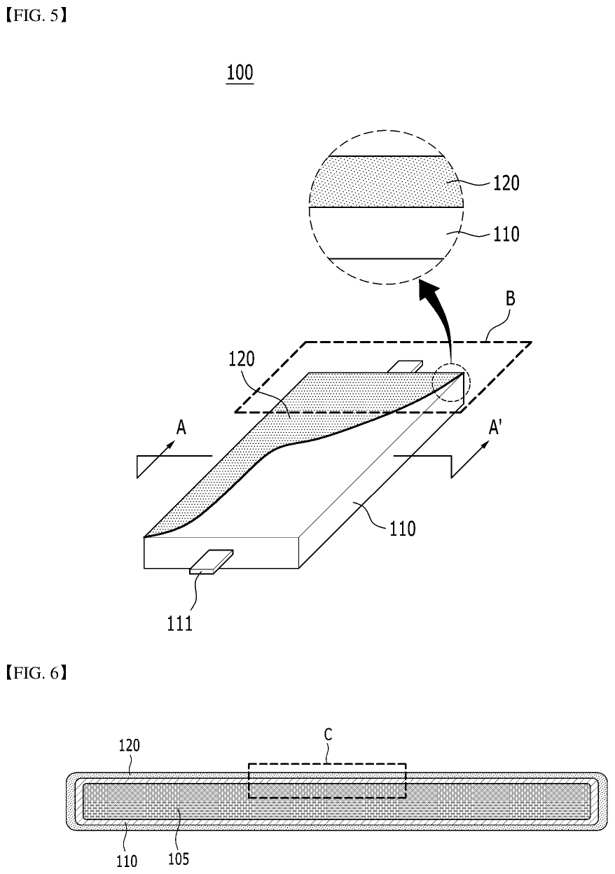

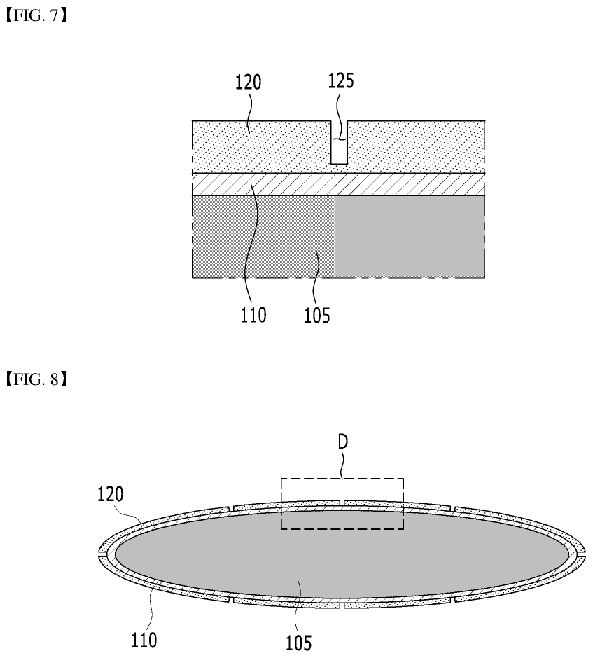

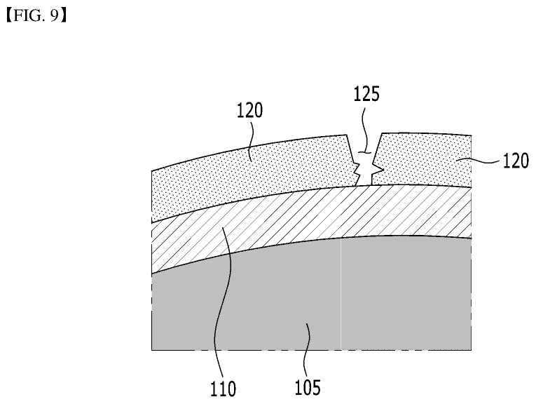

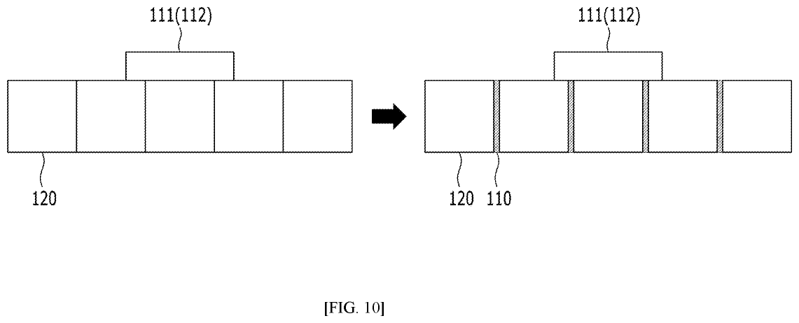

FIG. 5 is a diagram showing a secondary battery according to an embodiment of the present disclosure, which combines the components of FIG. 4 and includes a second battery case. Fog. 6 is a diagram showing a cross section cut along the line A-A′ of FIG. 5. FIG. 7 is an enlarged view of a section C of FIG. 6. FIG. 8 is a diagram showing when the secondary battery of FIG. 6 expands. FIG. 9 is an enlarged view of a section D of FIG. 8. FIG. 10 is an enlarged view of a section B of FIG. 5, which shows states in which first and second battery cases change due to expansion of a secondary battery.

Referring to FIGS. 5 and 6, the secondary battery 100 according to the present embodiment includes an electrode assembly 105, a first battery case 110 for housing the electrode assembly 105. and a second battery case 120 for covering the first battery case 110. At this time, the second battery case 120 is formed to have a color different from that of the first battery case 110.

Specifically, the first battery case 110 and the second battery case 120 may be formed by a combination of various colors, complementary colors can be used for high visibility, or black, yellow, red, etc. can be selected. Therefore, as will be described later, when the second battery case 120 ruptures due to the expansion of the secondary battery 100, and the color of the first battery case 110 is exposed to the outside, it can be easily distinguished with the naked eye. Further, the expansion degree of the secondary battery 100 can be predicted according to the exposure degree of the color of the first battery case 110.

Meanwhile, referring to FIG. 7, a groove 125 may be formed in the second battery case 120. A plurality of grooves 125 may be formed on the second battery case 120, and each of the grooves 125 may be formed to be spaced apart from each other on the second battery case 120.

At this time, referring to FIG. 5, a space between the electrode leads 111 and 112 of the secondary battery 100 may be defined as the longitudinal direction of the secondary battery 100. Therefore, the groove 125 may be formed along the longitudinal direction of the secondary battery 100 on the second battery case 120 of the secondary battery 100. In addition, the grooves 125 may be formed to be spaced apart from each other along the width direction of the secondary battery 100, which is a direction perpendicular to the length direction.

In addition, when forming the groove 125, the groove 125 may be formed on the second battery case 120 so that a portion of the second battery case 120 exists between the groove 125 and the first battery case 110. Therefore, the first battery case 110 may be formed not to be exposed by the groove 125.

As the electrolyte inside the secondary battery 100 is decomposed or a side reaction occurs, gas is generated and the secondary battery 100 expands, causing a swelling phenomenon, the second battery case 120 may be ruptured. Specifically, the groove 125 is formed on the second battery case 120, and the portion of the second battery case 120 in which the groove 125 is formed may be formed to have a thinner thickness than other portions. Therefore, when swelling of the secondary battery 100 occurs, the portion of the second battery case 120 in which the groove 125 is formed may be ruptured by the expansion force caused by the swelling phenomenon.

At this time, referring to FIGS. 8 and 9, as the second battery case 120 ruptures, a portion of the second battery case 120 between the groove 125 and the first battery case 110 can be removed. At this time, “removed” may mean that as the second battery case 120 ruptures, a portion of the second battery case 120 formed between the groove 125 and the first battery case 110 does not remain. Therefore, as the portion of the second battery case 120 located between the groove 125 and the first battery case 110 is removed, the groove 125 may be connected to the first battery case 110.

Further, as the groove 125 and the first battery case 110 are connected as described above, the first battery case 110 may be exposed to the outside. Therefore, as the first battery case 110 having a different color from the second battery case 120 is exposed to the outside, whether or not swelling phenomenon of the secondary battery 100 has occurred can be grasped with the naked eye. Further, the area of the first battery case 110 exposed by the groove 125 varies according to the degree of swelling, so that the degree of swelling and expansion of the battery can be predicted depending on the area.

Meanwhile, the first battery case 110 and the second battery case 120 may be formed to have different materials. Specifically, the second battery case 120 has less deformability against the expansion force compared to the first battery case 110, and thus, can be formed to rupture without copying to the expansion of the secondary battery 100. However, even if the second battery case 120 ruptures, the performance of the secondary battery 100 can be maintained because the first battery case 110 remains intact.

Therefore, the first battery case 110 may be formed to have greater deformability than the second battery case 120. Further, the material may be selected to have the above deformability.

Referring to FIG. 10, as described above, when swelling and expansion of the secondary battery 100 occur, the first battery case 110 may be exposed between the second battery cases 120. At this time, due to the characteristics of the cell swelling phenomenon, the first battery case 110 may start to be exposed from the center of the secondary battery 100. Further, when the overall swelling of the secondary battery 100 occurs, the first battery case 110 may be exposed at a plurality of positions through the plurality of grooves 125 formed on the second battery case 120 as shown in FIG. 10. In accordance with the exposure position and degree of exposure of the first battery case 110, the position and degree of swelling of the secondary battery 100 can be confirmed with the naked eye, and the degree of occurrence of the swelling phenomenon and the deterioration in performance of the secondary battery can be predicted through the area where the first battery case 110 is exposed.

Next, a method of manufacturing a secondary battery according to another embodiment of the present disclosure will be described. Since the description of the secondary battery described above can also be applied to the present embodiment, redundant descriptions will be omitted.

The manufacturing method of the secondary battery according to the present embodiment includes a step of housing an electrode assembly 105 in a first battery case 110; and a step of covering the first battery case 110 in which the electrode assembly 105 is housed with the second battery case 120. At this time, the second battery case 120 is formed to have a color different from that of the first battery case 110.

Further, a groove 125 may be formed in the second battery case 120. As described above, when swelling and expansion occur in the secondary battery 100, the second battery case 120 is ruptured, and as the first battery case 110 is exposed, it can be grasped with the naked eye.

In particular, the groove 125 formed on the second battery case 120 is formed along the longitudinal direction of the secondary battery 100, and when a swelling phenomenon occurs, the secondary battery 100 may be deformed by expansion.

The terms representing directions such as the front side, the rear side, the left side, the right side, the upper side, and the lower side have been used in the present embodiment, but the terms used are provided simply for convenience of description and may become different according to the position of an object, the position of an observer, or the like.

The above-mentioned secondary battery according to the present embodiment can be applied to various devices. Such a device can be applied to a vehicle means such as an electric bicycle, an electric vehicle, or a hybrid vehicle, but the present disclosure is not limited thereto, and is applicable to various devices that can use a secondary battery.

Although preferred embodiments of the present disclosure have been described in detail above, the scope of the present disclosure is not limited thereto, and various modifications and improvements can be made by those skilled in the art using the basic concepts of the present disclosure as defined in the appended claims, which also falls within the scope of the present disclosure.

### DESCRIPTION OF REFERENCE NUMERALS

100: secondary battery
105: electrode assembly
110: first battery case
120: second battery case
125: groove

1. A secondary battery comprising:
an electrode assembly;
a first battery case that houses the electrode assembly; and a second battery case that houses the first battery case,
wherein the second battery case has a different color from that of the first battery case.

2. The secondary battery according to claim 1, wherein a groove is formed in the second battery case.

3. The secondary battery according to claim 2, wherein the groove is formed in a plurality of grooves on the second battery case.

4. The secondary battery according to claim 3, wherein the plurality of grooves are formed to be spaced apart from each other on the second battery case.

5. The secondary battery according to claim 2, wherein
during an expansion of the secondary battery a portion of the second battery case in which the groove is formed is configured to ruptured.

6. The secondary battery according to claim 5, wherein the groove is configured to extend into and connect to the first battery case
as the second battery case ruptures.

7. The secondary battery according to claim 5, wherein
the first battery case is configured to be exposed to an outside of the secondary battery when the second battery case ruptured.

8. The secondary battery according to claim 1, wherein
the first battery case and the second battery case are formed of different materials.

9. The secondary battery according to claim 8, wherein the first battery case is formed to have greater deformability than the second battery case.

10. A method of manufacturing a secondary battery, comprising the steps of:
housing an electrode assembly in a first battery case; and
covering the first battery case in which the electrode assembly is housed with a second battery case,
wherein the second battery case has a color different from that of the first battery case.

11. The method of manufacturing a secondary battery according to claim 10, wherein a groove is formed in the second battery case.

12. A device comprising the secondary battery as set forth in claim 1.

13. The secondary battery according to claim 2, wherein a portion of the secondary battery case in which the groove is formed has a thickness less than a thickness of other portions of the secondary battery.

14. The secondary battery according to claim 8, wherein an area of the first battery case exposed by the groove varies according to the degree of expansion of the secondary battery.

15. The method of manufacturing a secondary battery according to claim 11, wherein during expansion of the secondary battery, a portion of the second battery case in which the groove is formed is ruptured.
